(19) United States
(12) Patent Application Publication
(10) Pub. No.: US 2016/0292651 A1
(43) Pub. Date: Oct. 6, 2016

(54) CALENDAR MANAGEMENT WITH FLEXIBLE DURATION MEETINGS

(71) Applicant: International Business Machines Corporation, Armonk, NY (US)

(72) Inventor: Mayank B. Bathiya, Jamnagar (IN)

(21) Appl. No.: 15/067,231

(22) Filed: Mar. 11, 2016

Related U.S. Application Data
(63) Continuation of application No. 14/672,289, filed on Mar. 30, 2015.

(51) Int. Cl. G06Q 10/10

(52) U.S. Cl. CPC G06Q 10/1095

(57) ABSTRACT

A flexible duration meeting invite is provided to allow and assist a meeting chairperson using prompt messages to unblock the calendars for rooms, resources, and/or people as soon as they are not required. Such flexible meeting scheduling allows and assists the individual participant to mark the meeting as completed with respect to his involvement and to unblock his calendar even though the meeting is still in progress. Such flexible duration meetings also allow the others to take informed decision and plan the best case scenarios.

### FIELD OF THE INVENTION

The present invention relates generally to the field of conference resources management, and more particularly to resource bookings.

### BACKGROUND OF THE INVENTION

Planning, organizing and conducting a conference can be challenging. For the smooth running of a conference, cooperation and participation of many individuals are needed and all important aspects of the conference must be covered. Such aspects include the chairperson or owner of the conference or meeting, participants, technical infrastructure to support the number of attendees, audio-visual facilities, projectors and communication equipment like phones, speakers and microphones.

When deciding on the dates and times for a conference or meeting, conference rooms and other associated resources have peak periods of high demand, quiet periods of low demand, and shoulder periods of variable demand. Accordingly, the arrangement of different conferences or meetings need to be carefully coordinated, especially, for a conference considering dates and times during a peak period.

### SUMMARY

In one aspect of the present invention, a method, a computer program product, and a system includes: specifying a set of meeting duration parameters including a start time, a minimum meeting duration, and a maximum meeting duration for the flexible duration meeting, wherein a calendar timeslot for each required room, resource, and participant is booked from the start time for the maximum meeting duration; monitoring a duration of the flexible duration meeting; responsive to the duration of the flexible duration meeting being equal to the minimum meeting duration, requesting a status of the meeting; and responsive to the status of the meeting being complete, unlocking a remaining calendar timeslot for each required room, resource, and participant, wherein the remaining calendar timeslot is the difference between a current time and an end time, the end time being the maximum meeting duration measured from the start time.

### BRIEF DESCRIPTION OF THE SEVERAL VIEWS OF THE DRAWINGS

FIG. 1 is a schematic view of a first embodiment of a system according to the present invention;

FIG. 2 is a flowchart showing a method performed, at least in part, by the first embodiment system; and

FIG. 3 is a schematic view of a machine logic (for example, software) portion of the first embodiment system.

### DETAILED DESCRIPTION

Conventionally, overbooking calendars for rooms, resources, and/or participants for a conference usually occurs. A flexible duration meeting invite is provided to allow and assist a meeting chairperson using prompt messages to unblock the calendars for rooms, resources, and/or people as soon as they are not required. Such flexible meeting scheduling allows and assists the individual participant to mark the meeting as completed with respect to his involvement and to unblock his calendar even though the meeting is still in progress. The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium, or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network, and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture, including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus, or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions, or acts, or carry out combinations of special purpose hardware and computer instructions.

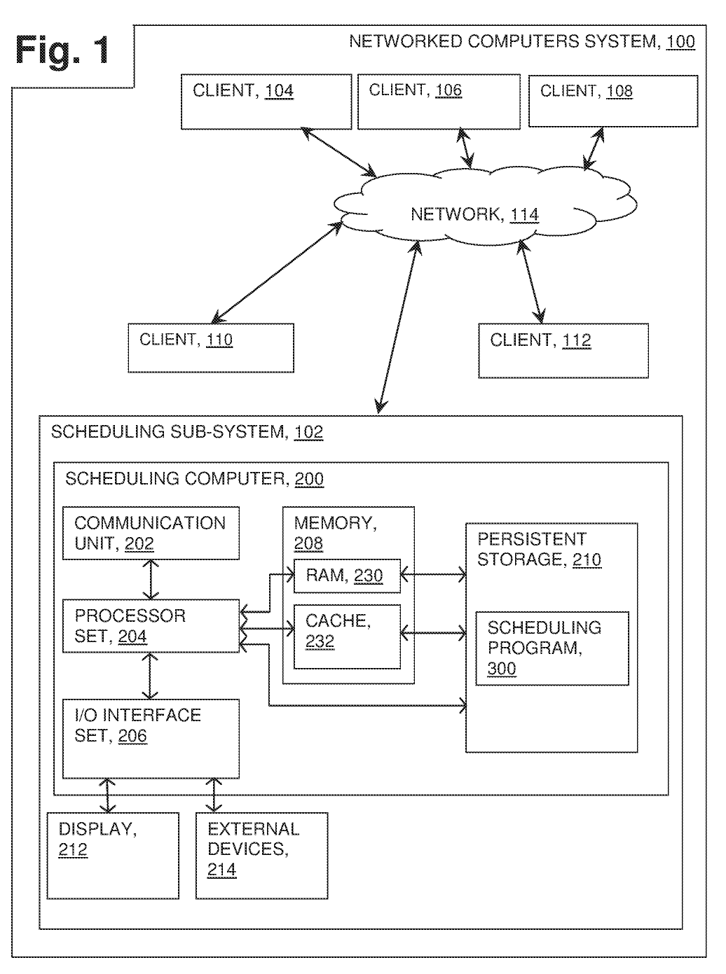

The present invention will now be described in detail with reference to the Figures. FIG. 1 is a functional block diagram illustrating various portions of networked computers system 100, in accordance with one embodiment of the present invention, including: scheduling sub-system 102; client sub-systems 104, 106, 108, 110, 112; communication network 114; scheduling computer 200; communication unit 202; processor set 204; input/output (I/O) interface set 206; memory device 208; persistent storage device 210; display device 212; external device set 214; random access memory (RAM) devices 230; cache memory device 232; and scheduling program 300.

Sub-system 102 is, in many respects, representative of the various computer sub-system(s) in the present invention. Accordingly, several portions of sub-system 102 will now be discussed in the following paragraphs.

Sub-system 102 may be a laptop computer, tablet computer, netbook computer, personal computer (PC), a desktop computer, a personal digital assistant (PDA), a smart phone, or any programmable electronic device capable of communicating with the client sub-systems via network 114. Program 300 is a collection of machine readable instructions and/or data that is used to create, manage and control certain software functions that will be discussed in detail below.

Sub-system 102 is capable of communicating with other computer sub-systems via network 114. Network 114 can be, for example, a local area network (LAN), a wide area network (WAN) such as the Internet, or a combination of the two, and can include wired, wireless, or fiber optic connections. In general, network 114 can be any combination of connections and protocols that will support communications between server and client sub-systems.

Sub-system 102 is shown as a block diagram with many double arrows. These double arrows (no separate reference numerals) represent a communications fabric, which provides communications between various components of sub-system 102. This communications fabric can be implemented with any architecture designed for passing data and/or control information between processors (such as microprocessors, communications and network processors, etc.), system memory, peripheral devices, and any other hardware component within a system. For example, the communications fabric can be implemented, at least in part, with one or more buses.

Memory 208 and persistent storage 210 are computer readable storage media. In general, memory 208 can include any suitable volatile or non-volatile computer readable storage media. It is further noted that, now and/or in the near future: (i) external device(s) 214 may be able to supply, some or all, memory for sub-system 102; and/or (ii) devices external to sub-system 102 may be able to provide memory for sub-system 102.

Program 300 is stored in persistent storage 210 for access and/or execution by one or more of the respective computer processors 204, usually through one or more memories of memory 208. Persistent storage 210: (i) is at least more persistent than a signal in transit; (ii) stores the program (including its soft logic and/or data), on a tangible medium (such as magnetic or optical domains); and (iii) is substantially less persistent than permanent storage. Alternatively, data storage may be more persistent and/or permanent than the type of storage provided by persistent storage 210.

Program 300 may include both machine readable and performable instructions, and/or substantive data (that is, the type of data stored in a database). In this particular embodiment, persistent storage 210 includes a magnetic hard disk drive. To name some possible variations, persistent storage 210 may include a solid state hard drive, a semiconductor storage device, read-only memory (ROM), erasable programmable read-only memory (EPROM), flash memory, or any other computer readable storage media that is capable of storing program instructions or digital information.

The media used by persistent storage 210 may also be removable. For example, a removable hard drive may be used for persistent storage 210. Other examples include optical and magnetic disks, thumb drives, and smart cards that are inserted into a drive for transfer onto another computer readable storage medium that is also part of persistent storage 210.

Communications unit 202, in these examples, provides for communications with other data processing systems or devices external to sub-system 102. In these examples, communications unit 202 includes one or more network interface cards. Communications unit 202 may provide communications through the use of either, or both, physical and wireless communications links. Any software modules discussed herein may be downloaded to a persistent storage device (such as persistent storage device 210) through a communications unit (such as communications unit 202).

I/O interface set 206 allows for input and output of data with other devices that may be connected locally in data communication with scheduling computer 200. For example, I/O interface set 206 provides a connection to external device set 214. External device set 214 will typically include devices such as a keyboard, keypad, a touch screen, and/or some other suitable input device. External device set 214 can also include portable computer readable storage media such as, for example, thumb drives, portable optical or magnetic disks, and memory cards. Software and data used to practice embodiments of the present invention, for example, program 300, can be stored on such portable computer readable storage media. In these embodiments the relevant software may (or may not) be loaded, in whole or in part, onto persistent storage device 210 via I/O interface set 206. I/O interface set 206 also connects in data communication with display device 212.

Display device 212 provides a mechanism to display data to a user and may be, for example, a computer monitor or a smart phone display screen.

The programs described herein are identified based upon the application for which they are implemented in a specific embodiment of the present invention. However, it should be appreciated that any particular program nomenclature herein is used merely for convenience, and thus the present invention should not be limited to use solely in any specific application identified and/or implied by such nomenclature.

Program 300 operates to set up a flexible (or floater) duration meeting. The flexible duration meeting has the capability to define a floating meeting duration at an individual level or at a team level. With the overall meeting duration, a participant can define their involvement with the meeting as a floating duration. Further, the participant can register certain patterns with respect to their involvement in the meeting. Alternatively, a meeting chairperson can register certain patterns with respect to the participant's involvement in the meeting.

Some embodiments of the present invention recognize the following facts, potential problems and/or potential areas for improvement with respect to the current state of the art: (i) overbooking frequently occurs for rooms and/or resources required for a conference; (ii) the exact time when a meeting is going to take place cannot always be guaranteed; (iii) problems may arise in an organization having too few conference rooms and/or resources with respect to the meeting activity of the employees; (iv) participants do not want to get interrupted during a meeting and want to complete an entire meeting in a single meeting room; and/or (v) an individual participant cannot mark the meeting as completed with respect to his involvement and unblock his calendar.

While initiating a meeting request, to be on the safer side, overbooking of rooms and resources occurs on a number of occasions. For example, very important meetings with external entities (such as important clients) may drive an overbooking of resources, etc. A recurring meeting where occasionally the meeting continues for a longer duration (e.g., a daily short meeting ends within 15 minutes most of the time, but the meeting is scheduled for at least 30 minutes according to the calendar for the participants, resources, and/or conference rooms). The exact duration of a meeting cannot always be pre-determined. Conventionally, such overbooking cannot be avoided.

Overbooking creates a real problem in an organization having fewer rooms and/or resources compared to the meeting activity of the employees. On one hand, people may not find the rooms and/or resources available for their future bookings and, hence, compromise on the date, time, or type of the room for the meeting. On the other hand, the desired room and/or resource might actually become available for the desired date or time when other teams finish their meetings early. Even in an organization with sufficient rooms and/or resources, the same problem may arise during peak hours of use.

Overbooking also creates a problem at the individual level. For example, a user wants to have a quick 5-minute discussion on an instant messaging system with a client whose calendar shows that the client has back to back meetings throughout the day. Hence, the client's status is going to remain “in meeting” for the whole day. The user's discussion is important but not urgent. So, the user does not want to disturb the client during the meeting. Meanwhile, the user is also interested in knowing if any of the clients meetings are overbooked (i.e. the meeting could actually end early) and, hence, there is a chance for the user to catch the client during that time.

Further, overbooking creates a problem at the team level. Consider a scenario where a single person chairs the status meeting of multiple teams one after the other. For example, a schedule for such a daily meeting is arranged as follows: 11:00 AM-11:15 AM Status meeting of team 1; 11:15 AM-11:30 AM Status meeting of team 2; 11:30 AM-11:45 AM Status meeting of team 3; 11:45 AM-12:00 PM Status meeting of team 4; 12:00 PM-12:15PM status meeting of team 5 and 12:15 AM-12:30 PM Status meeting of team 6. All six meetings share the same room, resources, and/or bridge. One of the problems in this scenario is that each meeting is dependent on the completion of the previous meeting(s). For example, members of team 5 may join the bridge at 12:00 PM, only to hear from the chairperson that a few more minutes are needed as the status call for team 4 is still in progress. Also, in such scenario, the chairperson has to send six separate meeting invites, or invitations, (one to each team). Meeting management activities such as cancelling all six meetings for the particular day, rescheduling it to another timeslot, or changing the room and/or bridge details has to be done separately.

According to some embodiments of the present invention, a flexible (floater) duration meeting invite is provided, such that the system and stakeholders are aware of the best case that are to be hoped instead of preparing for the worst by overbooking the calendars of rooms, resources, and/or participants. Thus, planning of the best case scenarios can happen in advance. For example, if teams that have bookings from 2 PM to 3 PM indicates that they can possibly vacate the room at 2:30 PM, a team that does not find any room, can take an informed decision to register a wait-listed booking for 2:30 PM. Further example, if a first person wants to book a meeting with a second person for the next day and finds out that the second person is not available on the timeslots when the first person is available, the first person may make an informed decision to book a timeslot where the second person is likely to be available because some of the second person's meetings already indicate that they may be completed early. In addition, the second person's calendar will also show to the second person that they are likely to be free by that time. Accordingly, the second person will make an informed decision to tentatively accept the new meeting request from the first person during a timeslot that conventionally would show up as being busy due to the meeting.

Further, for the recurring meeting, if there is a pattern in the meeting duration, that pattern can be used by a flexible duration meeting scheduler. For example, sometimes, in long-duration meetings, a team may have planned to take a periodic break in the middle of the meeting. However, that does not mean that team will take the break exactly at a certain time. Sometimes, as a pattern, a person may start some meetings late most of the time, and may want to inform the meeting scheduler of that pattern in the advance. For example, a client may specify with the meeting scheduler that if he does not join the meeting within two minutes of start time, then assume that he is still busy in a previous meeting. In that way, the meeting owner can drop the call and join exactly after some time lapse such as 15 minutes.

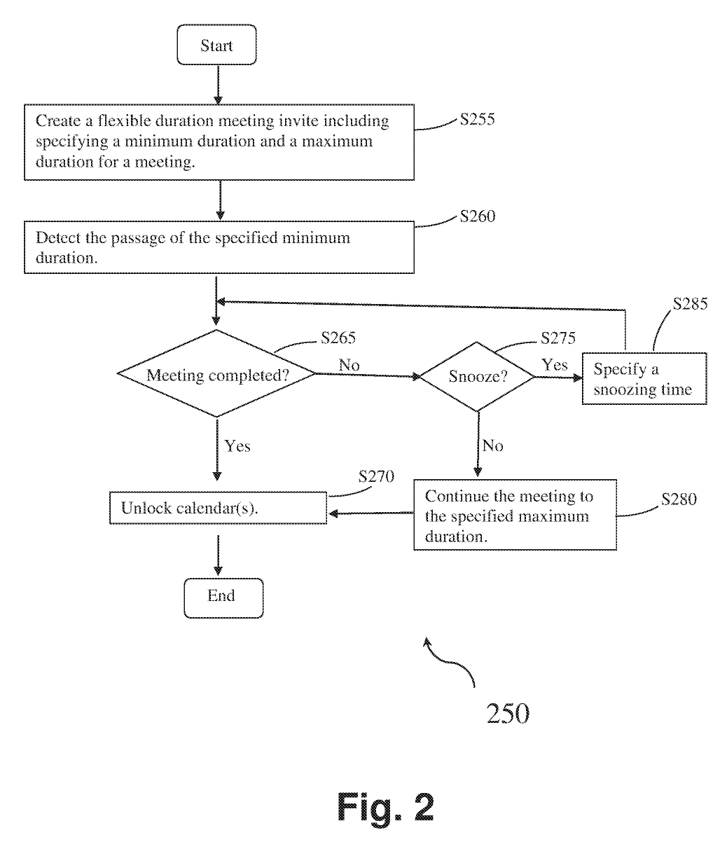

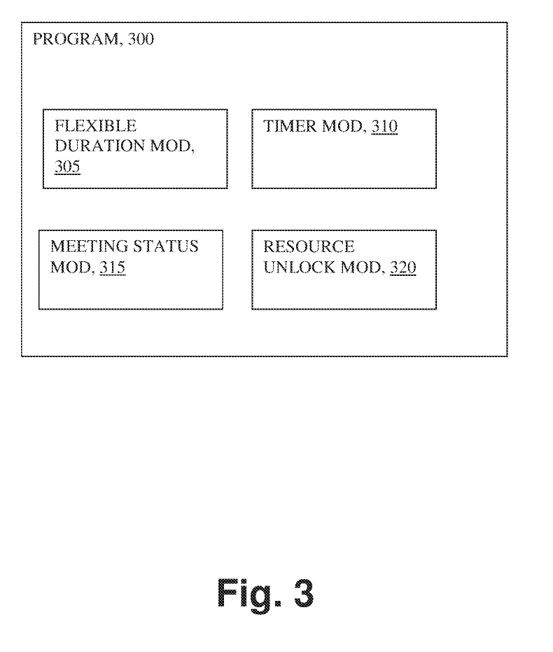

FIG. 2 shows flowchart 250 depicting a first method according to the present invention. FIG. 3 shows scheduling program 300 for performing at least some of the method steps of flowchart 250. This method and associated software will now be discussed, over the course of the following paragraphs, with extensive reference to FIG. 2 (for the method step blocks) and FIG. 3 (for the software blocks).

Processing proceeds to step S255 once program 300 begins from START, where flexible duration module 305 is used to input, by a meeting owner (or a meeting chairperson), the minimum meeting duration as well as the standard (maximum) meeting duration. In this exemplary embodiment, for a one-time meeting or a reoccurring meeting, the chairperson of a meeting can specify a set of meeting duration parameters including a start time, a minimum duration, a maximum duration, a meeting pattern, and/or a break duration. If the chairperson feels that his meeting may get completed before the scheduled end time (maximum duration), he specifies a minimum duration as well as a standard (maximum) duration for the meeting. The calendars for rooms, resources, and/or participants are booked according to the specified maximum meeting duration. For example, a meeting chairperson wants to setup a daily status meeting for 1 hour between 10 AM and 11 AM. He feels that the meeting will mostly get completed within 30 minutes. However, occasionally it requires 1 hour of time. So, he specifies the minimum duration as 30 minutes and a standard (maximum) duration as 1 hour.

Alternatively, an individual participant (e.g., a participant in a team meeting, a participant or a team in a multi-team meeting), is able to set a flexible duration for him and/or a subset of the meeting attendees. This is helpful in meeting scenarios where a person and/or team is no longer required once that the person and/or team provides an update. That person and/or team feels that although the meeting may go on for a slightly longer period, they are likely to leave the meeting after the first few minutes, perhaps after 15 minutes. In this scenario, as a participant, within the overall meeting duration, the participant defines his involvement with the meeting as a floating duration. For example, in a 2 hour meeting between 10 AM to 12 PM, a participant joins not earlier than 10:30 AM. As far as his involvement is concerned, the meeting goes on till 10:45 AM in the best case (minimum duration). In the worst case, the participant is out of the meeting at 11:00 AM (maximum duration).

Alternatively, other patterns for the flexible duration meeting can be registered in the flexible duration invites. For example, at an individual participant level, in a 4 hour brainstorming meeting, a participant can inform the scheduler and/or all the stakeholders in advance that he will take a 5-minute break at the end of each hour. For a multiple team meeting, as described above for a 6 team meeting, with such flexible duration meeting invite, each day using the prompt messages, system can tell the team members to join the meeting exactly at a time when the last meeting is about to complete. In some embodiments of the present invention, the scheduler gives control of the set of all six meetings to the chairperson. The chairperson needs to just send one common meeting invite for these six different meetings, which makes meeting management easier for him. For example, if he wants to cancel the meeting for a day, reschedule the meeting for the evening, change the reserved room and/or bridge details, he can do it as a block, or set, of all six meetings, rather than going to each individually scheduled meeting to perform the same repeated steps. Essentially, this sets up a tree structure of the set of meetings, i.e., a meeting having child meetings, which allows a user to create an n level tree structure of the meetings for better management of meetings and real time dependency management.

Processing proceeds to step S260, where timer module 310 determines whether the minimum meeting duration is passed. In this example, the minimum duration time is specified by a meeting owner or chairperson with respect to the whole meeting. Alternatively, the minimum duration time is specified by an individual participant with respect to his involvement in the meeting. Alternatively, the minimum duration time is specified by an individual team with respect to the team's involvement in a multi-team meeting. Further alternatively, the minimum duration refers to the break time specified in a long duration meeting.

Processing proceeds to step S265, where meeting status module 315 queries the meeting status by prompting the owner with a notification, or message. During the meeting, once the time specified as a minimum duration passes, the meeting status mod sends a message to the chairperson to have his consent that the meeting is already completed. Alternatively, a message is generated for an individual participant with respect to his involvement in the meeting. Alternatively, a message is provided to an individual team with respect to the team's involvement in a multi-team meeting. Further alternatively, the system provides a message regarding the break time specified in a long duration meeting, such as, “are you going to take a break?”

If “YES” branch is selected from step S265, processing proceeds to step S270, where resource unlock module 320 releases the booked meeting resources. In this exemplary embodiment, if the meeting chairperson chooses to say “Yes” to the prompted message, the resource unlock mod then takes care of unblocking the calendars of the rooms, resources, and/or participants for that particular occurrence. In addition, the resource unlock mod provides an explicit button to the chairperson to mark the meeting as completed before the scheduled end point (the maximum duration). The moment when meeting is marked as completed, the calendars for each of the rooms, resources, and/or participants are unblocked. Processing proceeds to “END.”

Alternatively, each participant has an option to mark the meeting as completed with respect to his involvement if “YES” is chosen by the participant. That means, meeting may still be going on, but that particular participant is out of the meeting and available now.

Alternatively, if “YES” is chosen by a team in a multi-team meeting, that team has an option to mark the meeting as completed with respect to the team's involvement in the multi-team meeting. Further alternatively, a status of break time is marked if “YES” is selected for the break time specified in a long duration meeting.

If “NO” branch is selected from step S265, processing proceeds to step S275, where meeting status module 315 presents a message asking whether to snooze. The chairperson has an option to snooze the prompt for meeting termination for a number of minutes. Alternatively, a snooze message is generated for an individual participant with respect to his involvement in the meeting. Alternatively, a snooze message is prompted for an individual team with respect to the team's involvement in a multi-team meeting. Further alternatively, the system prompts a snooze message regarding the break time specified in a long duration meeting.

If “NO” branch is selected from step S275, processing proceeds to step S280, where timer module 310 determines the maximum duration of the meeting. In this step, the meeting continues to the scheduled maximum duration, then the processing proceeds to step S270 where the chairperson confirms the completion of the meeting, and the calendars for each of the rooms, resources, and/or participants are unblocked. Processing then proceeds to “END.”

Alternatively, each participant has an option to mark the meeting as completed with respect to his involvement at the end of the maximum duration specified by him if “NO” is chosen by the participant. Alternatively, if “NO” is chosen by a team in a multi-team meeting, that team has an option to mark the meeting as completed at the end of the maximum duration specified by the team with respect to the team's involvement in the multi-team meeting.

Further alternatively, in the case of early conclusion of the meeting prior to the specified respective maximum duration, the chairperson, the particular participant, and the particular team in a multi-team meeting, may choose either to mark the meeting as completed at the early actual completion time or mark the meeting as completed at the maximum meeting duration specified. The moment when the flexible duration meeting is marked as completed, the calendars for each of the rooms, resources, and participants associated with the meeting are unblocked. Processing proceeds to “END.”

If “YES” branch is selected from step S275, processing proceeds to step S285, where timer module 310 requests that a snooze time be specified. In this step, the meeting chairperson specifies a time, for example 15 minutes, for snoozing. The specified time can be any number between the minimum duration and the maximum duration. After the specified snooze time elapses, the processing proceeds to step S265 where meeting status module 315 again queries the meeting status by prompt a message to ask the chairperson if the meeting has already completed. Based on the answer to the query, the processing repeats the above process steps. Alternatively, if a particular participant chooses to snooze and specifies a snoozing time with respect to his involvement, the processing proceeds the same steps as for the chairperson. Alternatively, if a team participant in a multi-team meeting chooses to snooze and specifies a snoozing time with respect to the team's involvement, the processing proceeds the same steps as for the chairperson.

Some embodiments of the present invention may include one, or more, of the following features, characteristics, and/or advantages: (i) the future possible availability of a participant and/or resource, even though today it shows as booked, can be known in advance for planning the best case scenarios; (ii) allows and assists a meeting chairperson with prompted messages to unblock the rooms, resources, and people as soon as they are not required; and/or (iii) the flexible meeting scheduler also allows and assists the individual participant to mark the meeting as completed with respect to his involvement and unblock his calendar even though meeting is still going on.

Some helpful definitions follow:

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein that are believed as maybe being new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: inclusive or; for example, A, B “and/or” C means that at least one of A or B or C is true and applicable.

User/subscriber: includes, but is not necessarily limited to, the following: (i) a single individual human; (ii) an artificial intelligence entity with sufficient intelligence to act as a user or subscriber; and/or (iii) a group of related users or subscribers.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

What is claimed is:

1. A method for managing a flexible duration meeting, the method comprising:
specifying a set of meeting duration parameters including a start time, a minimum meeting duration, and a maximum meeting duration for the flexible duration meeting, wherein a calendar timeslot for each required room, resource, and participant is booked from the start time for the maximum meeting duration;
monitoring a duration of the flexible duration meeting;
responsive to the duration of the flexible duration meeting being equal to the minimum meeting duration, requesting a status of the meeting; and
responsive to the status of the meeting being complete, unlocking a remaining calendar timeslot for each required room, resource, and participant, wherein the remaining calendar timeslot is the difference between a current time and an end time, the end time being the maximum meeting duration measured from the start time.

2. The method of claim 1, further comprising:
receiving, at a first time, the status of the meeting as snooze;
specifying a snoozing duration; and
requesting a status of the meeting when a time lapse from the first time to a current time is equal to the snoozing duration.

3. The method of claim 2, wherein the snoozing duration is a duration less than or equal to a remaining calendar timeslot for each required room, resource, and participant.

4. The method of claim 1, wherein the calendar timeslot is able to present a potential availability of the room, resource, and participant.

5. The method of claim 1, further comprising:
responsive to the duration of the flexible duration meeting being equal to the maximum duration, ceasing to monitor the duration of the flexible duration meeting.

6. The method of claim 1, wherein the step of specifying a set of meeting duration parameters is performed by one of the following: a meeting chairperson, a particular meeting participant, and a team.

7. The method of claim 1, wherein the set of meeting duration parameters further includes a meeting pattern.

8. The method of claim 7, wherein the meeting pattern is a duration of time after the start time for a break time.

9. The method of claim 7, wherein the meeting pattern includes one of joining the meeting at a first duration before the start time, joining the meeting at a second duration after the start time, and taking a third duration of break time at a specified time interval from the start time.

10. The method of claim 1, wherein the flexible duration meeting is one of the following types: a one-time meeting, a recurring meeting, and a multi-team meeting.

11. The method of claim 10, wherein the multi-team meeting includes one of the following: a meeting attended by a first plurality of teams at the same time, and a meeting attended by a second plurality of teams, wherein the second plurality of teams join the meeting one after another based on a pre-determined sequence.
